(19) United States
(12) Patent Application Publication
(10) Pub. No.: US 2006/0152455 A1
(43) Pub. Date: Jul. 13, 2006

(54) DRIVING METHOD AND DRIVING APPARATUS

(76) Inventors: Kuang-Feng Sung, Taichung County (TW); Jin-Sheng Hsieh, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,645

(22) Filed: Aug. 11, 2005

(30) Foreign Application Priority Data
Jan. 11, 2005 (TW) 94100695

(51) Int. Cl. G09G 3/32

(52) U.S. Cl. 345/82

(57) ABSTRACT

A driving apparatus for driving a plurality of display devices of a panel is provided. The driving apparatus comprises a controllable current source and a plurality of current storage and duplicating apparatuses. Wherein, each of the current storage and duplicating apparatuses is coupled to the controllable current source and one of the display devices corresponding thereto to receive a first current from the controllable current source, and to output a second current which is equal, or proportional to the first current to drive the display apparatus.

### CROSS-REFERENCE TO RELATED APPLICATION

This application claims the priority benefit of Taiwan application serial no. 94100695, filed on Jan. 11, 2005. All disclosure of the Taiwan application is incorporated herein by reference.

### BACKGROUND OF THE INVENTION

1. Field of the Invention

The present invention relates to a driving apparatus and a driving method of a display device, and more particularly, to a driving apparatus with a current storage and duplicating apparatus and a driving method thereof.

2. Description of the Related Art

Traditionally, an organic light-emitting diode (OLED) comprises an organic thin film between its transparent anode and metal cathode. With these film layers, electrons and holes combine in the organic thin film to release energy which converts into visible light. In addition, different organic materials can generate different color lights. By using different organic materials, a full-color display can be manufactured. Generally, advantages of an OLED display include: self-illumination, slim structure, high brightness, high fluorescence efficiency, high contrast, low response time (e.g., in a few microseconds), wide view angle, low power consumption, wide temperature range, and panel flexibility.

Generally, the organic light-emitting diode may be driven by using current for illumination. The amount of currents will determine brightness and color of the OLED. Accordingly, each light-emitting diode needs a driving circuit for controlling the current. The traditional method of controlling the current can be achieved by using switches to control the number of the functioning transistors in a current mirror. For example, a current-type digital-to-analog converter (DAC) uses this method.

FIG. 1 is a schematic drawing showing a prior art OLED display. Referring to FIG. 1, the prior art OLED display 100 comprises a panel 102 and a driving circuit 104. The panel 102 comprises a plurality of matrix-arranged OLEDs 112. The driving circuit 104 comprises a plurality of controllable current sources 114, wherein, each controllable current source 114 is coupled to a corresponding OLED 112. The controllable current source 114 outputs a current to drive the OLED 112 coupled thereto for illumination. The amount of the current determines the brightness and color of the OLED. Accordingly, each OLED 112 requires a controllable current source 114 in the traditional technology.

As described, since each OLED requires a controllable current source, the prior art driving circuit 104 needs a huge area and is costly. In addition, the error of the manufacturing process of the controllable current source also causes high current errors output from it. It is thus desired to develop a method and an apparatus which can reduce the area and cost of the driving circuit, eliminate the current error resulting from the manufacturing process error of the controllable current source, and increase the display efficiency and uniformity of the OLED.

### SUMMARY OF THE INVENTION

Accordingly, the present invention is directed to a driving apparatus which reduces the area and cost of the driving apparatus. The driving apparatus further prevents brightness errors occurred due to each OLED using a different controllable current source in the prior art technology.

In addition, the present invention is also directed to a driving method to reduce the area and cost of the driving apparatus. The driving method completely prevents brightness errors occurred due to each OLED using a different controllable current source in the prior art technology.

The driving apparatus of the present invention drives a plurality of display devices of a panel. The driving apparatus comprises a controllable current source and a plurality of current storage and duplicating apparatuses. Wherein, each of the current and duplicating apparatuses is coupled to the controllable current source and a display device to receive a first current from the controllable current source, and to output a second current which is equal, or proportional, to the first current to drive the display device.

According to an embodiment of the present invention, each of the current storage and duplicating apparatuses comprises: a first switch, a second switch, a third switch, a transistor, and a capacitor. Wherein, a terminal of the first switch is coupled to the controllable current source, and another terminal of the first switch is coupled to a terminal of the second switch, a terminal of the third switch, and a drain of the transistor, another terminal of the second switch is coupled to a gate of the transistor, and another terminal of the third switch is coupled to the display device.

According to an embodiment of the present invention, each of the current storage and duplicating apparatuses comprises: a first switch, a second switch, a first transistor, a second transistor, a capacitor, and a capacitor. Wherein, a terminal of the first switch is coupled to the controllable current source, another terminal of the first switch is coupled to a gate of the first transistor, a gate and a drain of the second transistor, and the capacitor. In addition, a terminal of the second switch is coupled to the display device, and another terminal of the second switch is coupled to a drain of the first transistor.

According to an embodiment of the present invention, the driving apparatus further comprises a first transistor, and a drain of the first transistor is coupled to a gate of the first transistor and the controllable current source. Each of the current storage and duplicating apparatuses comprises a first switch, a second switch, a second transistor, and a capacitor. Wherein, a terminal of the first switch is coupled to a gate of the first transistor, another terminal of the first switch is coupled to a gate of the second transistor and the capacitor, a terminal of the second switch is coupled to the display device, and another terminal of the second switch is coupled to the drain of the second transistor.

According to an embodiment of the present invention, the display device comprises an LED or an OLED.

According to an embodiment of the present invention, the controllable current source comprises: a constant current source; a first transistor, wherein a gate and a drain of the first transistor are coupled to the constant current source; a current mirror apparatus comprising a plurality of second transistors. In addition, a gate of each of the second transistors is coupled to the gate of the first transistor; and a plurality of switches. Wherein, a terminal of each of the switches is individually coupled to a drain of one of the second transistors, and another terminal of each of the switches is coupled to an output terminal.

The driving method of the present invention is adapted for a driving apparatus to drive a plurality of display devices of a panel. The driving apparatus comprises a controllable current source and a plurality of current storage and duplicating apparatuses. Wherein, each of the current storage and duplicating apparatuses is individually coupled to the controllable current source and one of the display devices. The driving method comprises: each of the current storage and duplicating apparatuses individually receiving a first current from the controllable current source, and outputting a second current which is equal, or proportional to the first current to drive each of the display devices.

According to an embodiment of the present invention, each of the current storage and duplicating apparatuses individually executes a current storage function during one of a plurality of time sequences, and executes a function of driving one of the display devices corresponding thereto during a time sequence different from the time sequences of executing the current storage function, or executes a function of driving all the display devices on a same time sequence different from the time sequences of executing the current storage function.

According to an embodiment of the present invention, each of the current storage and duplicating apparatuses individually executes a current storage function during one of a plurality of time sequences, and executes a function of driving all of the display devices after all of the current storage and duplicating apparatuses have completed the execution of current storage function.

According to an embodiment of the present invention, each of the current storage and duplicating apparatuses comprises a first switch, a second switch, a third switch, a transistor, and a capacitor. Wherein, a terminal of the first switch is coupled to the controllable current source, another terminal of the first switch is coupled to a terminal of the second switch, a terminal of the third switch, and a drain of the transistor, another terminal of the second switch is coupled to a gate of the transistor, and another terminal of the third switch is coupled to the display device. The driving method includes: when a first current source storage and duplicating apparatus of the current storage and duplicating apparatuses executes the current storage function, the controllable current source generates a first current, the first switch and the second switch of the first current source storage and duplicating apparatus are turned on, and a voltage difference of a gate to a source of the transistor is stored in the capacitor. The third switch is then turned on; when the first current source storage and duplicating apparatus executes the driving function, and the transistor generates a second current equal to the first current.

According to an embodiment of the present invention, each of the current storage and duplicating apparatuses comprises a first switch, a second switch, a first transistor, a second transistor, and a capacitor. Wherein, a terminal of the first switch is coupled to the controllable current source, another terminal of the first switch is coupled to a gate of the first transistor, a gate and a drain of the second transistor, and the capacitor, a terminal of the second switch is coupled to the display device, and another terminal of the second switch is coupled to a drain of the first transistor. The driving method includes: when a first current source storage and duplicating apparatus of the current storage and duplicating apparatuses executes the current storage function, the controllable current source generates a first current, the first switch of the first current source storage and duplicating apparatus is turned on, and a voltage difference of a gate to a source of the second transistor is stored in the capacitor. The second switch is then turned on; when the first current source storage and duplicating apparatus executes the driving function, and the first transistor generates a second current proportional to the first current, wherein a ratio of the second current to the first current is equal to a ratio of an aspect ratio of the second transistor to an aspect ratio of the first transistor. Additionally, in another embodiment of the present invention, the driving method further comprises turning on the second switches during any of the time sequences. The current storage function of the current storage and duplicating apparatuses, and the driving function of OLEDs corresponding thereto are simultaneously executed.

According to an embodiment of the present invention, the driving apparatus further comprises a first transistor, a drain of the first transistor is coupled to a gate of the first transistor and the controllable current source, each of the current storage and duplicating apparatuses comprises a first switch; a second switch; a second transistor; and a capacitor. Wherein, a terminal of the first switch is coupled to a gate of the first transistor, another terminal of the first switch is coupled to a gate of the second transistor and the capacitor, a terminal of the second switch is coupled to the display device, and another terminal of the second switch is coupled to the drain of the second transistor. In the driving method, when a first current source storage and duplicating apparatus of the current storage and duplicating apparatuses executes the current storage function, the controllable current source generates a first current, the first switch of the first current source storage and duplicating apparatus is turned on, and a voltage difference of a gate to a source of the first transistor is stored in the capacitor. The second switch is then turned on; when the first current source storage and duplicating apparatus executes the driving function, and the first transistor generates a second current proportional to the first current, wherein a ratio of the second current to the first current is equal to a ratio of an aspect ratio of the second transistor to an aspect ratio of the first transistor. Additionally, in another embodiment of the present invention, the driving method further comprises turning on the second switches during any of the time sequences. The current storage function of the current storage and duplicating apparatuses, and the driving function of OLEDs corresponding thereto are simultaneously executed.

According to an embodiment of the present invention, the display device comprises an LED or an OLED.

Accordingly, each organic light-emitting diode over the panel corresponds to a current storage and duplicating apparatus. Thus only one controllable current source of the driving apparatus is required. The amount of the controllable current sources can be effectively reduced. The advantages of the present invention at least comprises reducing the area and cost of the whole driving apparatus, and eliminating brightness errors due to the reason that each of OLEDs uses a controllable current source different from each other in the prior art technology.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a schematic drawing showing a prior art OLED display.

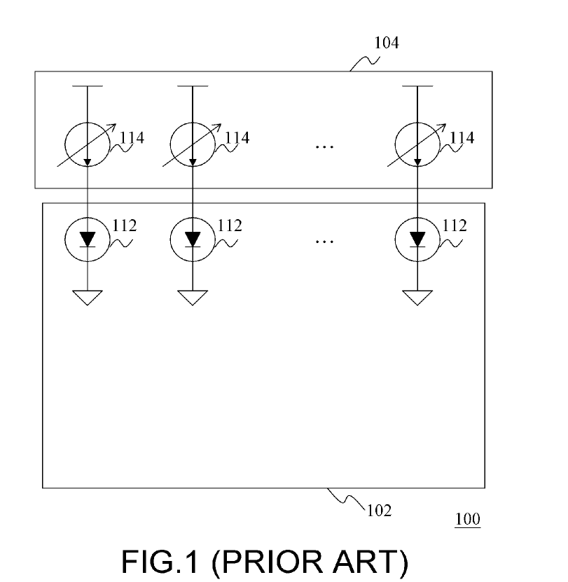

FIG. 2 is a schematic drawing showing an OLED display according to an embodiment of the present invention.

FIG. 3 is a schematic drawing showing a controllable current source according to an embodiment of the present invention.

FIG. 4 is a schematic drawing showing a driving apparatus for an OLED display according to an embodiment of the present invention.

FIG. 5 is a schematic drawing showing driving sequences of an OLED display according to an embodiment of the present invention.

FIG. 6 is a schematic drawing showing driving sequences of an OLED display according to another embodiment of the present invention.

FIG. 7 is a schematic drawing showing a driving apparatus of an OLED according to another embodiment of the present invention.

FIG. 8 is a schematic drawing showing driving sequences of an OLED according to another embodiment of the present invention.

FIG. 9 is a schematic drawing showing a driving apparatus of an OLED according to an embodiment of the present invention.

### DESCRIPTION OF SOME EMBODIMENTS

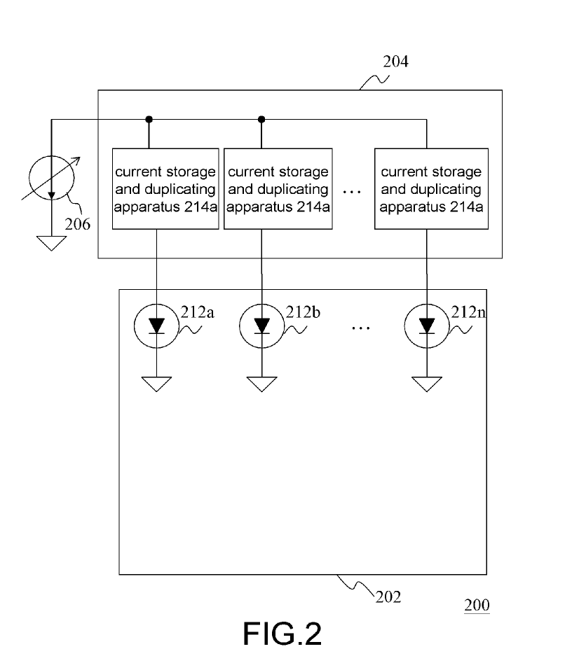

FIG. 2 is a schematic drawing showing an OLED display according to an embodiment of the present invention. Referring to FIG. 2, the OLED display 200 comprises, for example, a panel 202 and a driving apparatus 204. The panel comprises, for example, a plurality of OLEDs 212a-212n. These OLEDs 212a-212n can be arranged in an array or in a A-shape. The driving apparatus 204 comprises a controllable current source 206 and a plurality of current storage and duplicating apparatuses 214a-214n coupled to the controllable current source 206. The current storage and duplicating apparatuses 214a-214n are coupled to the OLEDs 212a-212n, respectively. The current storage and duplicating apparatuses 214a-214n individually output currents to drive the OLEDs 212a-212n coupled thereto to make them illuminate, respectively. The amount of these currents determines brightness and colors of the OLEDs 212a-212n.

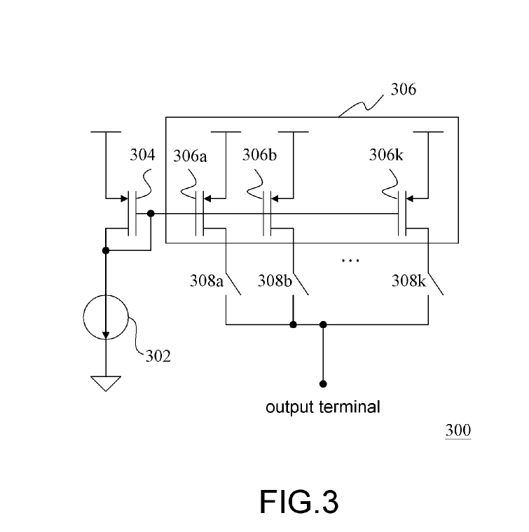

FIG. 3 is a schematic drawing showing a controllable current source according to an embodiment of the present invention. Referring to FIG. 3, the described controllable current source 206 can include the controllable current source 300, for example. The controllable current source 300 comprises, for example, a constant current source 302, a transistor 304, a current mirror apparatus 306 and a plurality of switches 308a-308k. The current mirror apparatus 306 comprises a plurality of transistors 306a-306k. Gates of the transistors 306a-306k are coupled to the gate of the transistor 304. Drains of the transistors 306a-306k are individually coupled to the switches 308a-308k corresponding thereto, respectively. The gate and the drain of the transistor 304 are coupled to the constant current source 302. In FIG. 3, the controllable current source 300 has k sections of adjustable resolutions. Wherein, each of the transistors 306a-306k has an equivalent aspect ratio. The constant current source 302 outputs a constant current. The constant current flows through the transistor 304 to control turn-on or turn-off of the switches 308a-308k so as to determine the output currents of the output terminal. The output currents are then input to all current storage and duplicating apparatuses 214a-214n in FIG. 2.

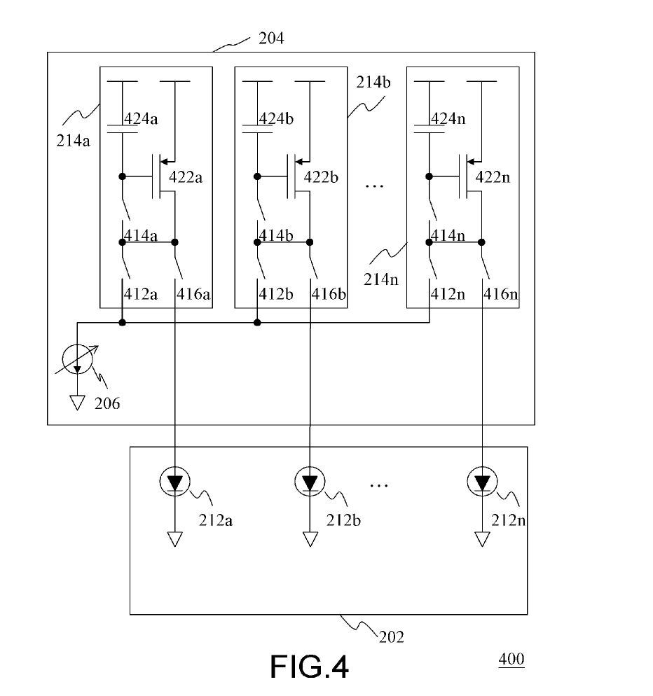

FIG. 4 is a schematic drawing showing a driving apparatus for an OLED display according to an embodiment of the present invention. The OLED display 400 in FIG. 4 is similar to the OLED display 200 in FIG. 2. The difference between them is in the structure of the current storage and duplicating apparatuses 214a-214n. In FIG. 4, the current storage and duplicating apparatus 214a comprises, for example, switches 412a, 414a, and 416a; a transistor 422a, and a capacitor 424a. Wherein, a terminal of the switch 412a is coupled to the controllable current source 206, and another terminal of the switch 412a is coupled to a terminal of the switch 414a, a terminal of the switch 416a, and the drain of the transistor 422a. Another terminal of the switch 414a is coupled to the capacitor 424a, and the gate of the transistor 422a. Another terminal of the switch 416a is coupled to the OLED 212a. In addition, the structure of the current storage and duplicating apparatuses 214b-214n is similar to or same as that of the current storage and duplicating apparatus 214a.

Referring to FIG. 4, in an embodiment of the present invention, when the current storage and duplicating apparatus 214a executes the current storage function, the controllable current source 206 generates a first current for the OLED 212a. The switches 412a and 414a are turned on. The first current then flows from the source of the transistor 422a to the controllable current source 206 through the switches 412a and 414a. The transistor 422a, corresponding to the current of the controllable current source 206, generates a voltage difference Vgs of the gate to the source. The voltage difference is then stored in the capacitor 424a. The current storage and duplicating apparatus 214a thus finishes the current storage function.

Referring to FIG. 4, in an embodiment of the present invention, the current storage and duplicating apparatus 214a executes the driving function. Because the capacitor 424a stores the voltage difference Vgs of the gate to the source of the transistor 422a, the current output from the transistor 422a is equal to the first current desired for the OLED 212a when the switch 416a is turned on.

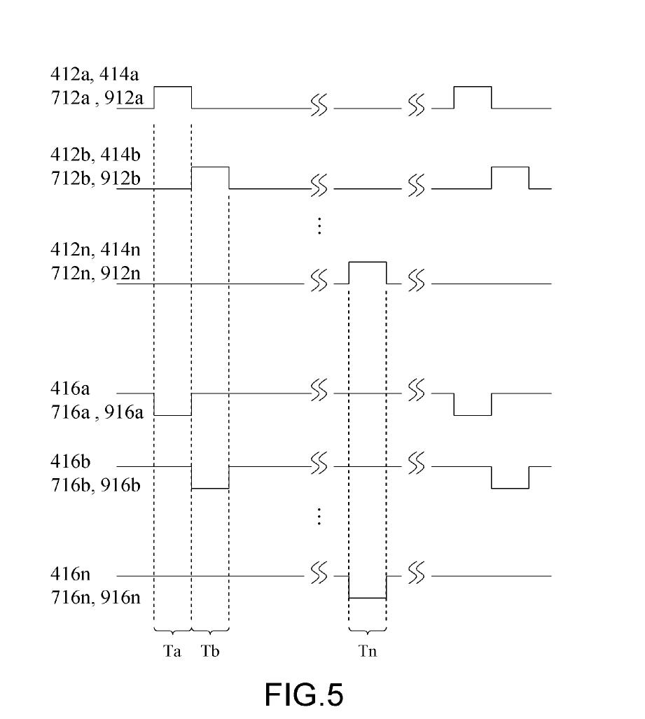

FIG. 5 is a schematic drawing showing driving sequences of an OLED display according to an embodiment of the present invention. Referring to FIG. 5, all switches are turned on in high voltages and turned off in low voltages. First, during the time period Ta, the switches 412a and 414a are turned on, the voltage difference Vgs of the gate to the source of the transistor 422a is stored in the capacitor 424a, and the switch 416a is turned off. During the time period Tb, the switches 412b and 414b are turned on, the voltage difference Vgs of the gate to the source of the transistor 422b is stored in the capacitor 424b, and the switch 416b is turned off. Note that except during the time period Ta, the switches 412a and 414a are turned off, and the switch 416a is turned on, and the OLED 212a is driven by the desired current. Accordingly, the current storage and duplicating apparatuses 214a-214n execute the current storage function during the time periods Ta, Tb-Tn, respectively. During other time periods, the current storage and duplicating apparatuses 214a-214n execute the driving function of the OLEDs 212a-212n corresponding thereto, respectively.

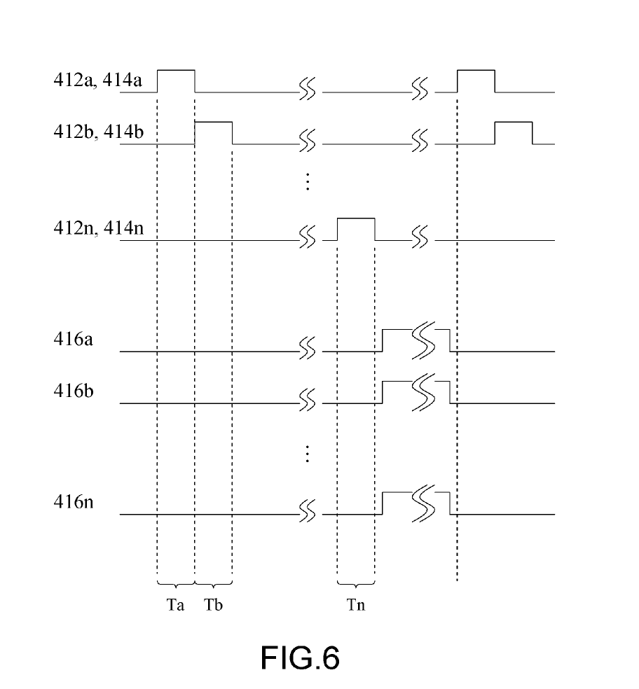

FIG. 6 is a schematic drawing showing driving sequences of an OLED display according to another embodiment of the present invention. Referring to FIG. 6, all switches are turned on in high voltages and turned off in low voltages. What is different is that the current storage and duplicating apparatuses 214b-214n execute the current storage function during the time periods Ta, Tb-Tn, respectively. After finishing the current storage function, all of the switches 416a-416n are turned on to execute the driving function of the OLEDs 212a-212n.

Referring to FIG. 2 or 4, in this invention only one controllable current source 206 is required. The amount of the controllable current sources can be effectively reduced. The advantages include not only effectively reducing the area and cost of the driving apparatus 204, but since only one controllable current source 206 is used, it also completely prevents the brightness errors occurred because of the reason that each of OLEDs uses a different controllable current source in the prior art technology.

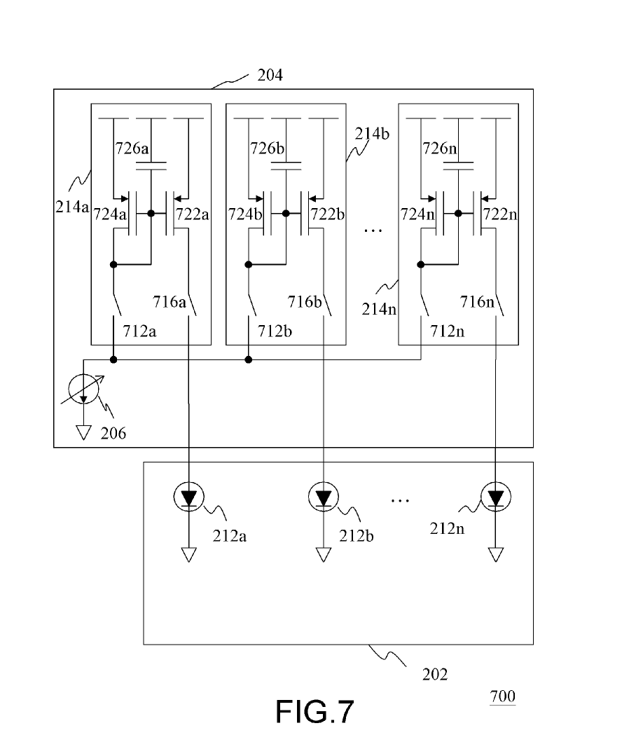

FIG. 7 is a schematic drawing showing a driving apparatus of an OLED display according to another embodiment of the present invention. The OLED display 700 in FIG. 7 is similar to the OLED display 200 in FIG. 2. What is different is in the structure of the current storage and duplicating apparatuses 214a-214n. In FIG. 7, the current storage and duplicating apparatus 214a comprises, for example, switches 712a and 716a; transistors 722a and 724a, and a capacitor 724a. Wherein, a terminal of the switch 712a is coupled to the controllable current source 206, and another terminal of the switch 712a is coupled to the gate of the transistor 722a, the gate and the drain of the transistor 724a, and the capacitor 726a. A terminal of the switch 714a is coupled to the OLED 212a. Another terminal of the switch 714a is coupled to the drain of the transistor 722a. In addition, the structure of the current storage and duplicating apparatuses 214b-214n is similar or the same to that of the current storage and duplicating apparatus 214a.

Referring to FIG. 7, in an embodiment of the present invention, when the current storage and duplicating apparatus 214a executes the current storage function, the controllable current source 206 generates a first current for the OLED 212a. The switch 712a is turned on. The first current then flows from the source of the transistor 724a to the controllable current source 206 through the switch 712a. The transistor 722a, corresponding to the current of the controllable current source 206, generates a voltage difference Vgs of the gate to the source. The voltage difference is then stored in the capacitor 726a. The current storage and duplicating apparatus 214a thus finishes the current storage function.

Referring to FIG. 7, in an embodiment of the present invention, the current storage and duplicating apparatus 214a executes the driving function, and the aspect ratio of the transistor 722a is M times of that of the transistor 724a. When the voltage difference Vgs of the gate to the source of the transistor 724a is stored in the capacitor 726a, once the switch 716a is turned on, the current output from the transistor 422a is M times of the first current.

Referring to FIG. 5, all switches are turned on in high voltages and turned off in low voltages. Waveforms of the switches 712a, 712b-712n, and 716a, 716b-716n are shown in FIG. 5. The current storage and duplicating apparatuses 714a-714n execute the current storage function during the time periods Ta-Tn, respectively. During other time periods, the current storage and duplicating apparatuses 714a-714n execute the driving function of the organic light-emitting diodes 212a-212n corresponding thereto, respectively.

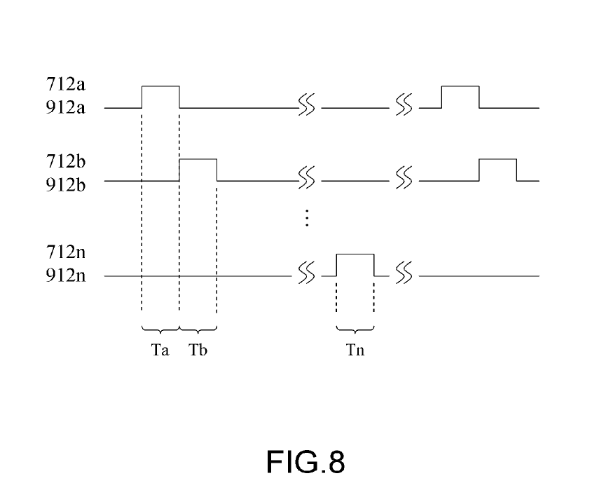

FIG. 8 is a schematic drawing showing driving sequences of an OLED display according to another embodiment of the present invention. Referring to FIGS. 7 and 8, in an embodiment of the present invention, all of the switches 716a-716n are turned on during any time period. As a result, the current storage function of the current storage and duplicating apparatuses 214a, 214b-214n, and the driving function of the OLEDs 212a-212n corresponding thereto are simultaneously executed. As shown in FIG. 8, the current storage and duplicating apparatuses 214a-214n execute the current storage function during the time periods Ta, Tb-Tn, respectively, and the driving function of the OLEDs 212a-212n corresponding thereto keeps going.

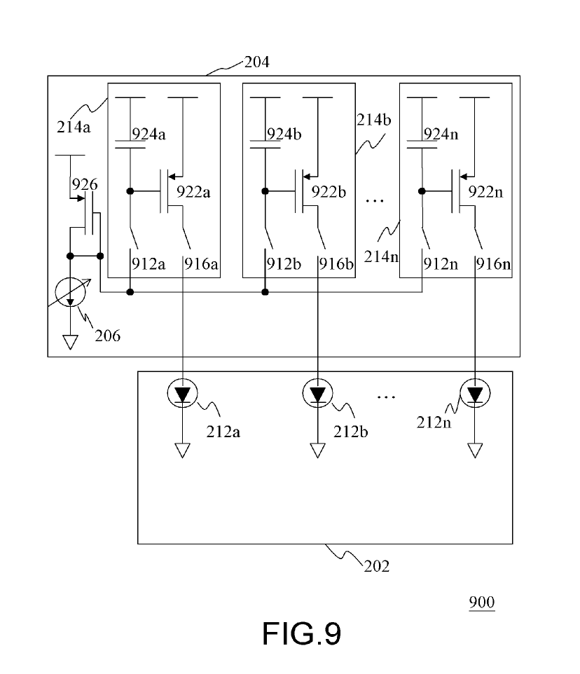

FIG. 9 is a schematic drawing showing a driving apparatus of an OLED display according to an embodiment of the present invention. The OLED display 900 in FIG. 9 is similar to the OLED display 200 in FIG. 2. What is different is in the driving apparatus 204 and the structure of the current storage and duplicating apparatuses 214a-214n. In FIG. 9, the current storage and duplicating apparatus 214a comprises, for example, switches 912a and 916a; a transistor 922a, and a capacitor 924a. Wherein, a terminal of the switch 912a is coupled to the gate of the transistor 926, and another terminal of the switch 912a is coupled to the gate of the transistor 922a, and the capacitor 924a. A terminal of the switch 916a is coupled to the OLED 212a. Another terminal of the switch 916a is coupled to the drain of the transistor 922a. In addition, the structure of the current storage and duplicating apparatuses 214b-214n is similar to or same as that of the current storage and duplicating apparatus 214a. In addition to the current storage and duplicating apparatuses 214a-241n, the driving apparatus 204 further comprises a transistor 926. The gate of the transistor 926 is coupled to the switches 912a-912n of the current storage and duplicating apparatuses 214a-214n, and the drain of the transistor 926 is coupled to its gate and the controllable current source 206.

Referring to FIG. 9, in an embodiment of the present invention, when the transistor 926 and the current storage and duplicating apparatus 214a execute the current storage function, the controllable current source 206 generates a first current for the OLED 212a. The first current then flows from the source of the transistor 926 to the controllable current source 206. Because the gate and the drain of the transistor 926 are coupled, a voltage difference Vgs of the gate to the source is generated corresponding to the current of the controllable current source 206. Further, because the switch 912a is turned on, the voltage difference Vgs of the gate to the source is then stored in the capacitor 924a through the switch 912a. The current storage and duplicating apparatus 214a thus finishes the current storage function.

Referring to FIG. 9, in an embodiment of the present invention, the current storage and duplicating apparatus 214a executes the driving function, and the aspect ratio of the transistor 922a is M times of that of the transistor 926a. When the voltage difference Vgs of the gate to the source of the transistor 926 is stored in the capacitor 924a, once the switch 916a is turned on, the current output from the transistor 922a is M times of the first current.

Referring to FIG. 5, all switches are turned on in high voltages and turned off in low voltages. Waveforms of the switches 912a, 912b-912n, and 916a, 916b-916n are shown in FIG. 5. The current storage and duplicating apparatuses 214a-214n execute the current storage function during the time periods Ta-Tn, respectively. During other time periods, the current storage and duplicating apparatuses 214a-214n execute the driving function of the OLEDs 212a-212n corresponding thereto, respectively.

52 Referring to FIGS. 9 and 8, in an embodiment of the present invention, all of the switches 916a, 916b-916n are turned on during any time period. As a result, the current storage function of the current storage and duplicating apparatuses 214a-214n, and the driving function of the OLEDs 214a-214n corresponding thereto are simultaneously executed. As shown in FIG. 8, the current storage and duplicating apparatuses 214a-214n execute the current storage function during the time periods Ta, Tb-Tn, respectively, and the driving function of the OLEDs 212a-212n corresponding thereto keeps going.

In summary, each OLED over the panel corresponds to a current storage and duplicating apparatus. Thus, only one controllable current source of the driving apparatus is required. The amount of the controllable current sources can be effectively reduced. The advantages of the present invention at least include reducing the area and cost of the whole driving apparatus and avoid brightness errors occurred due to the reason that each of OLEDs uses a controllable current source different from each other in the prior art technology.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A driving apparatus for driving a plurality of display devices of a panel, comprising:
a controllable current source; and
a plurality of current storage and duplicating apparatuses, wherein each of the current and duplicating apparatuses is coupled to the controllable current source and a display device to receive a first current from the controllable current source, and to output a second current which is equal or proportional to the first current to drive the display device.

2. The driving apparatus of claim 1, wherein each of the current storage and duplicating apparatuses comprises:
a first switch;
a second switch;
a third switch;
a transistor; and
a capacitor;
wherein a terminal of the first switch is coupled to the controllable current source, another terminal of the first switch is coupled to a terminal of the second switch, a terminal of the third switch, a drain of the transistor, and another terminal of the second switch is coupled to the transistor and a gate of the transistor, and another terminal of the third switch is coupled to the display device.

3. The driving apparatus of claim 1, wherein each of the current storage and duplicating apparatuses comprises:
a first switch;
a second switch;
a first transistor;
a second transistor; and
a capacitor;
wherein a terminal of the first switch is coupled to the controllable current source, another terminal of the first switch is coupled to a gate of the first transistor, a gate and a drain of the second transistor, and the capacitor, wherein a terminal of the second switch is coupled to the display device, and another terminal of the second switch is coupled to a drain of the first transistor.

4. The driving apparatus of claim 1, wherein the driving apparatus further comprises a first transistor, a drain of the first transistor is coupled to a gate of the first transistor and the controllable current source, and each of the current storage and duplicating apparatuses comprises:
a first switch;
a second switch;
a second transistor; and
a capacitor;
wherein a terminal of the first switch is coupled to a gate of the first transistor, another terminal of the first switch is coupled to a gate of the second transistor and the capacitor, a terminal of the second switch is coupled to the display device, and another terminal of the second switch is coupled to the drain of the second transistor.

5. The driving apparatus of claim 1, wherein the display device comprises a light-emitting diode or an organic light-emitting diode.

6. The driving apparatus of claim 1, wherein the controllable current source comprises:
a constant current source;
a first transistor, wherein a gate and a drain of the first transistor are coupled to the constant current source;
a current mirror apparatus comprising a plurality of second transistors, wherein a gate of each of the second transistors is coupled to the gate of the first transistor; and
a plurality of switches, wherein a terminal of each of the switches is individually coupled to a drain of one of the second transistors, and another terminal of each of the switches is coupled to an output terminal.

7. A driving method of a driving apparatus for driving a plurality of display devices of a panel, the driving apparatus comprising a controllable current source, and a plurality of current storage and duplicating apparatuses, wherein each of the current storage and duplicating apparatuses is individually coupled to the controllable current source and one of the display devices, the driving method comprising:
each of the current storage and duplicating apparatuses individually receives a first current from the controllable current source, and outputs a second current which is equal, or proportional to the first current to drive each of the display devices.

8. The driving method of claim 7, wherein each of the current storage and duplicating apparatuses executes a current storage function during one of a plurality of time sequences, and executes a function of driving one of the display devices corresponding thereto during a time sequence different from the time sequences of executing the current storage function, or executes a function of driving all the display devices on a same time sequence different from the time sequences of executing the current storage function.

9. The driving method of claim 7, wherein each of the current storage and duplicating apparatuses individually executes a current storage function during one of a plurality of time sequences, and the current storage and duplicating apparatuses execute a function of driving all of the display devices after all of the current storage and duplicating apparatuses finish the current storage function.

10. The driving method of claim 7, wherein each of the current storage and duplicating apparatuses comprises a first switch, a second switch, a third switch, a transistor, and a capacitor, wherein a terminal of the first switch is coupled to the controllable current source, another terminal of the first switch is coupled to a terminal of the second switch, a terminal of the third switch, and a drain of the transistor, another terminal of the second switch is coupled to a gate of the transistor, and another terminal of the third switch is coupled to the display device, the driving method comprising:
when a first current source storage and duplicating apparatus of the current storage and duplicating apparatuses executes a current storage function, the controllable current source generating a first current, the first switch and the second switch of the first current source storage and duplicating apparatus is turned on, a voltage difference of a gate to a source of the transistor is stored in the capacitor; and
turning on the third switch, when the first current source storage and duplicating apparatus executes the driving function, the transistor generating a second current equal to the first current.

11. The driving method of claim 7, wherein each of the current storage and duplicating apparatuses comprises a first switch; a second switch; a first transistor; a second transistor; and a capacitor, wherein a terminal of the first switch is coupled to the controllable current source, another terminal of the first switch is coupled to a gate of the first transistor, a gate and a drain of the second transistor, and the capacitor, a terminal of the second switch is coupled to the display device, and another terminal of the second switch is coupled to a drain of the first transistor, the driving method comprising:
when a first current source storage and duplicating apparatus of the current storage and duplicating apparatuses executes the current storage function, the controllable current source generating a first current, the first switch of the first current source storage and duplicating apparatus is turned on, a voltage difference of a gate to a source of the second transistor is stored in the capacitor; and
turning on the second switch, when the first current source storage and duplicating apparatus executes the driving function, the first transistor generating a second current proportional to the first current, wherein a ratio of the second current to the first current is equal to a ratio of an aspect ratio of the second transistor to an aspect ratio of the first transistor.

12. The driving method of claim 11, further comprising:
turning on the second switches during any of the time sequences; the current storage function of the current storage and duplicating apparatuses, and the driving function of organic light-emitting diodes corresponding thereto are simultaneously executed.

13. The driving method of claim 7, wherein the driving apparatus further comprises a first transistor, a drain of the first transistor is coupled to a gate of the first transistor and the controllable current source, each of the current storage and duplicating apparatuses comprises a first switch; a second switch; a second transistor; and a capacitor, wherein a terminal of the first switch is coupled to a gate of the first transistor, another terminal of the first switch is coupled to a gate of the second transistor and the capacitor, a terminal of the second switch is coupled to the display device, and another terminal of the second switch is coupled to the drain of the second transistor, the driving method comprising:
when a first current source storage and duplicating apparatus of the current storage and duplicating apparatuses executes the current storage function, the controllable current source generating a first current, the first switch of the first current source storage and duplicating apparatus is turned on, a voltage difference of a gate to a source of the first transistor is stored in the capacitor; and
turning on the second switch, when the first current source storage and duplicating apparatus executes the driving function, the first transistor generating a second current proportional to the first current, wherein a ratio of the second current to the first current is equal to a ratio of an aspect ratio of the second transistor to an aspect ratio of the first transistor.

14. The driving method of claim 13, further comprising:
turning on the second switches during any of the time sequences; the current storage function of the current storage and duplicating apparatuses, and the driving function of organic light-emitting diodes corresponding thereto are simultaneously executed.

15. The driving method of claim 7, wherein the display device comprises a light-emitting diode or an organic light-emitting diode.
